(19) United States
(12) Patent Application Publication
(10) Pub. No.: US 2006/0096179 A1
(43) Pub. Date: May 11, 2006

(54) CMP composition containing surface-modified abrasive particles

(75) Inventors: Bin Lu, Naperville, IL (US); Li Wu, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 10/982,080

(22) Filed: Nov. 5, 2004

(51) Int. Cl. C09K 3/14

(52) U.S. Cl. 51/307

(57) ABSTRACT

The invention provides a polishing composition comprising (a) particles of an abrasive comprising a first metal oxide and a second metal oxide adhered to at least a portion of a surface of the first metal oxide, (b) a water-soluble or water-emulsifiable polymer, wherein the water-soluble or water-emulsifiable polymer coats at least a portion of the second metal oxide such that the zeta potential of the abrasive is changed, and (c) water. The invention further provides a method of chemically-mechanically polishing a substrate through use of such a polishing composition.

### FIELD OF THE INVENTION

This invention pertains to a polishing composition and a method for polishing a substrate using the same.

### BACKGROUND OF THE INVENTION

Compositions and methods for polishing (e.g., planarizing) the surface of a substrate are well known in the art. Polishing slurries (also known as polishing slurries) typically contain an abrasive material in an aqueous solution and are applied to a surface by contacting the surface with a polishing pad saturated with the slurry composition. Typical abrasive materials include silicon dioxide, cerium oxide, aluminum oxide, zirconium oxide, and tin oxide. U.S. Pat. No. 5,527,423, for example, describes a method for chemically-mechanically polishing a metal layer by contacting the surface with a polishing slurry comprising high purity fine metal oxide particles in an aqueous medium. The polishing composition is typically used in conjunction with a polishing pad (e.g., polishing cloth or disk). Suitable polishing pads are described in U.S. Pat. Nos. 6,062,969, 6,117,000, and 6,126,532, which disclose the use of sintered polyurethane polishing pads having an open-celled porous network, and U.S. Pat. No. 5,489,233, which discloses the use of solid polishing pads having a surface texture or pattern. Alternatively, the abrasive material can be incorporated into the polishing pad. U.S. Pat. No. 5,958,794 discloses a fixed abrasive polishing pad.

Conventional polishing compositions typically are not entirely satisfactory at planarizing semiconductor wafers. In particular, polishing slurries can have less than desirable polishing rates, and their use in polishing semiconductor surfaces can result in poor surface quality. Because the performance of a semiconductor wafer is directly associated with the planarity of its surface, it is crucial to use a polishing composition that has a high polishing efficiency, uniformity, and removal rate, and leaves a high quality polish with minimal surface defects.

The difficulty in creating an effective polishing composition for semiconductor wafers stems from the complexity of the semiconductor wafer. Semiconductor wafers are typically composed of a substrate, on which a plurality of transistors has been formed. Integrated circuits are chemically and physically connected into a substrate by patterning regions in the substrate and layers on the substrate. To produce an operable semiconductor wafer and to maximize the yield, performance, and reliability of the wafer, it is desirable to polish select surfaces of the wafer without adversely affecting underlying structures or topography. In fact, various problems in semiconductor fabrication can occur if the process steps are not performed on wafer surfaces that are adequately planarized.

As integrated circuit devices become smaller, there is a need to reduce dishing, erosion, and defectivity that can occur as a result of the planatization process. One component of polishing slurries that has seen little improvement is the abrasive. Despite the advantages of polishing compositions comprising metal oxide particles consisting of a single metal oxide, these polishing compositions suffer from several disadvantages. The polishing compositions often become colloidally unstable (i.e., the metal oxide particles coagulate and fall out of suspension) within certain pH ranges. For instance, polishing compositions comprising silica particles are known to be colloidally unstable at mildly acidic pH (e.g., pH of about 4 to about 6). Such colloidal instability and the resulting precipitation of the metal oxide particles severely limit the effectiveness of these polishing compositions. Metal oxide particles often form aggregates consisting of very small primary particles that are strongly adhered to other primary particles in a 3-dimensional network which are considered irreducible, i.e., they cannot be further broken down to the size of the primary particles, thus providing an effective lower limit to the particle size of the abrasive particles. Polishing slurries comprising silicon dioxide cause fewer microscratches than slurries comprising aluminum oxide, but exhibit low removal rates against some barrier materials used in integrated circuit device fabrication as compared to slurries comprising aluminum oxide. Slurries comprising aluminum oxide possess advantages of colloidal stability and good removal rates against barrier materials, but cause an unacceptable amount of microscratches in chemical-mechanical polishing.

In order to overcome the disadvantages of abrasive particles comprising single metal oxides, there have been a number of attempts to use abrasives comprising two or more metal oxides. For example, U.S. Patent Application Publication No. 2003/0047710 A1 discloses a polishing slurry consisting essentially of a mixture of at least two inorganic metal oxides selected from the group consisting of ceria, silica, alumina zirconia, germania, and titanic. Other attempts have focused on binary metal oxide abrasives that are composites of two metal oxides. For example, U.S. Pat. No. 6,447,694 discloses polishing compositions comprising alumina-silica composite-based metal oxide powders, wherein the alumina-silica composite is prepared from AlC₃ and SiCl₄ by a co-fuming method

Thus, a need remains for compositions and methods that will exhibit desirable planarization efficiency, uniformity, and removal rate during the polishing and planarization of substrates, while minimizing defectivity, such as surface imperfections and damage to underlying structures and topography during polishing and planarization.

The invention provides such a composition and method. These and other advantages of the invention, as well as additional inventive features, will be apparent from the description of the invention provided herein.

### BRIEF SUMMARY OF THE INVENTION

The invention provides a polishing composition comprising (a) particles of an abrasive comprising a first metal oxide and a second metal oxide adhered to at least a portion of a surface of the first metal oxide, (b) a water-soluble or water-emulsifiable polymer, wherein the water-soluble or water-emulsifiable polymer coats at least a portion of the second metal oxide such that the zeta potential of the abrasive is changed, and (c) water.

The invention further provides a method of chemically-mechanically polishing a substrate, comprising (i) contacting a substrate with a polishing pad and a polishing composition comprising (a) particles of an abrasive comprising a first metal oxide and a second metal oxide adhered to at least a portion of a surface of the first metal oxide, (b) a water-soluble or water-emulsifiable polymer, wherein the water-soluble or water-emulsifiable polymer coats at least a portion of the second metal oxide such that the zeta potential of the abrasive is changed, and (c) water, (ii) moving the polishing pad relative to the substrate with the polishing composition therebetween, and (iii) abrading at least a portion of the substrate to polish the substrate.

### DETAILED DESCRIPTION OF THE INVENTION

The invention is directed towards a polishing composition for chemical-mechanical polishing of a substrate. The polishing composition comprises (a) particles of an abrasive comprising a first metal oxide and a second metal oxide adhered to at least a portion of a surface of the first metal oxide, (b) a water-soluble or water-emulsifiable polymer, wherein the water-soluble or water-emulsifiable polymer coats at least a portion of the second metal oxide such that the zeta potential of the abrasive is changed, and (c) water.

The abrasive used in conjunction with the invention comprises a first metal oxide and a second metal oxide that is adhered to at least a portion of the surface of the first metal oxide. Such an abrasive is hereinafter referred to as a composite metal oxide. The first metal oxide and the second metal oxide are different metal oxides but otherwise can be any suitable metal oxides. The first and second metal oxides desirably are independently selected from the group consisting of alumina, silica, titania, ceria, zirconia, germania, magnesia, and tantalum oxide. In one embodiment, the first metal oxide is silica. Preferably, the second metal oxide is alumina or ceria.

The abrasive can be formed by any suitable method. Several methods of forming composite metal oxides are known in the art. For example, one method of preparing composite metal oxides comprises co-precipitation of two metal oxides from suitable precursors in aqueous solution. Combustion of aerosols of mixed-metal metalloorganic alcohol solutions with oxygen or air in a process of flame spray pyrolysis has been used to prepare composite metal oxide particles. Composite metal oxide particles also can be obtained via reaction of a first metal oxide with a halide or alkoxide of a second metal.

The second metal oxide can be adhered to a portion of the surface of the first metal oxide in any suitable manner. Generally, the second metal oxide is adhered to a portion of the surface of the first metal oxide through one or more covalent bonds, one or more electrostatic interactions, one or more hydrogen bonds, one or more Van der Waals interactions, or combinations thereof. Preferably, the second metal oxide is adhered to a portion of the surface of the first metal oxide through one or more covalent bonds.

The second metal oxide can be adhered to any suitable amount of the surface of the first metal oxide particles. Preferably, the second metal oxide is adhered to about 5% or more (e.g., about 5% to about 50%, about 5% to about 75%, about 5% to about 90%, or about 5% to about 100%), more preferably about 10% or more (e.g., about 10% to about 50%, about 10% to about 75%, about 10% to about 90%, or about 10% to about 100%), and most preferably about 15% or more (e.g., about 15% to about 50%, about 15% to about 75%, about 15% to about 90%, or about 15% to about 100%) of the surface of the first metal oxide.

The abrasive particles can have any suitable average diameter. Typically, the abrasive particles have an average diameter of about 5 nm or more (e.g., about 10 nm or more). Preferably, the abrasive particles have an average diameter of about 200 nm or less (e.g., about 150 nm or less, or about 100 nm or less, or about 75 nm or less). More preferably, the abrasive particles have an average diameter of about 10 nm to about 75 nm.

The first and second metal oxides can be present in the polishing composition in any suitable amount. The total amount of metal oxide present in the polishing composition is about 0.01 wt. % or more, typically about 0.1 wt. % or more, and more typically about 1 wt. % or more. Typically, the total amount of metal oxide present in the polishing composition is no greater than about 40% by weight, more typically no greater than about 30% by weight, and most typically no greater than about 20% by weight, of the polishing composition (e.g., about 0.1 wt. % to about 20 wt. %, about 1 wt. % to about 10 wt. %, or about 1 wt. % to about 5 wt. %).

The polymer used in conjunction with the invention is selected from the group consisting of water-soluble and water-emulsifiable polymers (which includes copolymers). The polymer can be an anionic, cationic, or nonionic polymer (e.g., polyvinyl alcohol). As utilized herein, the term “water-soluble” refers to a polymer that has a solubility of about 0.1 mg/ml or more (e.g., about 1 mg/ml or more) in water at 25° C. Preferably, the water-soluble polymer is freely soluble in water at 25° C. As utilized herein, the term “water-emulsifiable” refers to a polymer that forms a stable, oil-in-water emulsion at 25° C.

The polymer can be an anionic polymer. Preferably, the anionic polymer comprises repeating units selected from the group consisting of carboxylic acid, sulfonic acid, and phosphonic acid functional groups. More preferably, the anionic polymer comprises repeating units selected from the group consisting of acrylic acid, methacrylic acid, itaconic acid, maleic acid, maleic anhydride, vinyl sulfonic acid, 2-(methacryloyloxy)ethanesulfonic acid, styrene sulfonic acid, 2-acrylamido-2-methylpropane sulfonic acid, vinylphosphonic acid, 2-methacroyloxy)ethylphosphate, and combinations thereof.

The polymer can be a cationic polymer. Preferably, the cationic polymer comprises repeating groups comprising at least one amine group. Suitable amine functional groups can be primary, secondary, tertiary, or quaternary (i.e., ammonium groups). More preferably, the cationic polymer comprises repeating units selected from the group consisting of allylamine, vinylamine, ethyleneimine, vinyl pyridine, diethylamnoethyl methacrylate, diallyldimethylammonium chloride, methacryloyloxyethyltrimethylammonium sulfate, and combinations thereof. As those of ordinary skill in the art will readily understand, the aforementioned ionic repeating units can be protonated or unprotonated/deprotonated depending upon the pH of the polishing composition and the pKₐ of the particular polymer. More specifically, if the pH of the polishing composition is less than the pKₐ of the polymer, the aforementioned unit of the polymer will be protonated. If, however, the pH of the polishing composition is greater than the pH of the polymer, the aforementioned unit of the polymer will be unprotonated/deprotonated.

The polymer can be adhered to the second metal oxide in any suitable manner. Generally, the polymer is adhered to the second metal oxide through one or more covalent bonds, one or more electrostatic bonds, one or more hydrogen bonds, one or more Van der Waals bonds, or combinations thereof. Preferably, the polymer is adhered to the second metal oxide by electrostatic bonds.

It is well known in the art that different metal oxides, at a given pH, differ in surface charge. Thus, at a given pH, a particle having a surface comprising two or more different metal oxides will have a nonuniform surface that can be characterized as having regions of differing surface charges corresponding to the different metal oxides. The anionic or cationic polymer, when bound to an abrasive particle by electrostatic forces, will associate with a region having an opposite charge to the anionic or cationic polymer. Thus, the particle will typically not be uniformly coated with the polymer, to the extent that the surface of the particle is not uniform. In the limiting instances where the first metal oxide is completely, or nearly completely, covered with the second metal oxide, the abrasive particle can be uniformly coated with the polymer.

In addition to being adhered to the second metal oxide of the abrasive particles, the polymer also can be adhered to a portion of the surface of the first metal oxide, when the first metal oxide comprises at least a portion of the surface of the abrasive particle. While not wishing to be bound to any particular theory, it is believed that attachment of the polymer to the surface of the second metal oxide provides for further colloidal stability by shielding the particles from the attractive forces that lead to agglomeration under conditions which typically cause the polishing composition to be colloidally unstable.

The zeta potential of the abrasive particles will typically change upon the addition of the polymer, generally towards the opposite sign. The zeta potential of a particle refers to the difference between the electrical charge of the ions surrounding the particle and the electrical charge of the bulk solution (e.g., the liquid carrier and any other components dissolved therein). Generally, a particle with a positive zeta potential can interact electrostatically with an anionic polymer with the result that the zeta potential becomes less positive, or even negative. Similarly, a particle with a negative zeta potential can interact electrostatically with a cationic polymer with the result that the zeta potential becomes less negative, or even positive. Preferably, the zeta potential of the abrasive particles will change by at least 5 mV in the presence of the anionic or cationic polymer. More preferably, the zeta potential of the abrasive particles will change by at least 10 mV in the presence of the anionic or cationic polymer.

Preferably, the abrasive particles, when the second metal oxide is at least partially coated by the polymer, are colloidally stable. The term colloid refers to the suspension of abrasive particles in the liquid carrier. Colloidal stability refers to the maintenance of that suspension through time. In the context of this invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of particles in the abrasive composition ([C] in terms of g/ml) is less than or equal to 0.5 (i.e., {[13]−[T]}/[C]≦0.5). More preferably, the value of [B]−[T]/[C] is less than or equal to 0.3, and most preferably is less than or equal to 0.1.

The polishing composition desirably has a pH of about 2 or more (e.g., about 3 or more). Preferably, the polishing composition has a pH of about 12 or less (e.g., about 11 or less). More preferably, the pH of the polishing composition is about 3 to about 10.

The polishing composition optionally comprises an acid. In certain embodiments, the acid is an inorganic acid. Preferably, the inorganic acid is selected from the group consisting of nitric acid, phosphoric acid, sulfuric acid, salts thereof, and combinations thereof. The acid can also be an organic acid. Preferably, the organic acid is selected from the group consisting of oxalic acid, malonic acid, tartaric acid, acetic acid, lactic acid, propionic acid, phthalic acid, benzoic acid, citric acid, succinic acid, salts thereof, and combinations thereof.

The polishing composition optionally comprises a chemical oxidizing agent. The chemical oxidizing agent can be any suitable oxidizing agent. Suitable oxidizing agents include inorganic and organic per-compounds, bromates, nitrates, chlorates, chromates, iodates, iron and copper salts (e.g., nitrates, sulfates, EDTA, and citrates), rare earth and transition metal oxides (e.g., osmium tetraoxide), potassium ferricyanide, potassium dichromate, periodic acid, and the like. A per-compound (as defined by Hawley's Condensed Chemical Dictionary) is a compound containing at least one peroxy group (—O—O—) or a compound containing an element in its highest oxidation state. Examples of compounds containing at least one peroxy group include but are not limited to hydrogen peroxide and its adducts such as urea hydrogen peroxide and percarbonates, organic peroxides such as benzoyl peroxide, peracetic acid, and di-tert-butyl peroxide, monopersulfates (SO₅²⁻) dipersulfates (S₂O₈²⁻), and sodium peroxide. Examples of compounds containing an element in its highest oxidation state include but are not limited to periodic acid, periodate salts, perbromic acid, perbromate salts, perchloric acid, perchlorate salts, perboric acid, perborate salts, and permanganates. The oxidizing agent preferably is hydrogen peroxide.

Any suitable amount of the oxidizing agent can be present in the polishing composition of the invention. Desirably, the oxidizing agent is present in the polishing composition in an amount of about 0.1 wt % to about 30 wt. %. Preferably, the oxidizing agent is present in the polishing composition in an amount of about 0.3 wt. % to about 17 wt. %. More preferably, the oxidizing agent is present in the polishing composition in an amount of about 0.5 wt. % to about 10 wt. %.

The polishing composition can further comprise a corrosion inhibitor (i.e., a film-forming agent). The corrosion inhibitor can be any suitable corrosion inhibitor. Typically, the corrosion inhibitor is an organic compound containing a heteroatom-containing functional group. For example, the corrosion inhibitor can be a heterocyclic organic compound with at least one 5- or 6-member heterocyclic ring as the active functional group, wherein the heterocyclic ring contains at least one nitrogen atom, for example, an azole compound. Preferably, the corrosion inhibitor contains at least one azole group. More preferably, the corrosion inhibitor is selected from the group consisting of 1,2,3-triazole, 1,2,4-triazole, benzotriazole, benzimidazole, benzothiazole, and mixtures thereof. Most preferably, the corrosion inhibitor is benzotriazole. The amount of corrosion inhibitor used in the polishing composition typically is about 0.0001 wt. % to about 3 wt. % (preferably about 0.001 wt. % to about 2 wt. %) based on the total weight of the polishing composition.

The polishing composition optionally further comprises one or more other additives. Such additives include any suitable surfactant and/or rheological control agent, including viscosity enhancing agents and coagulants (e.g., polymeric rheological control agents, such as, for example, urethane polymers), acrylates comprising one or more acrylic subunits (e.g., vinyl acrylates and styrene acrylates), and polymers, copolymers, and oligomers thereof, and salts thereof. Suitable surfactants include, for example, anionic surfactants, cationic surfactants, anionic polyelectrolytes, cationic polyelectrolytes, nonionic surfactants, amphoteric surfactants, fluorinated surfactants, mixtures thereof, and the like.

The polishing composition of the invention can be produced by any suitable technique, many of which are known to those skilled in the art. The polishing composition of the invention can be produced by any suitable technique, many of which are known to those skilled in the art. The polishing composition can be prepared in a batch or continuous process. Generally, the polishing composition is prepared by combining the components of the polishing composition. The term “component” as used herein includes individual ingredients (e.g., abrasives, acids, oxidizing agents, etc.) as well as any combination of ingredients (e.g., corrosion inhibitors, surfactants, etc.).

For example, the polishing composition can be prepared by (i) providing a solution or emulsion of the water-soluble or water-emulsifiable polymer in water, (ii) providing a dispersion of composite metal oxide abrasive particles in water using any suitable means for preparing such a dispersion, (iii) adjusting the pH of the dispersion of abrasive particles, (iv) adding a suitable amount of the aqueous solution or emulsion of the polymer to the dispersion of abrasive particles, and (v) optionally adding suitable amounts of an acid, a surfactant, an oxidizing agent, a corrosion inhibitor, or combinations thereof to the mixture.

Alternatively, the polishing composition can be prepared by (i) providing a solution or emulsion of the water-soluble or water-emulsifiable polymer in water, (ii) providing a dispersion of composite metal oxide abrasive particles in water using any suitable means for preparing such a dispersion, (iii) adjusting the pH of the mixture, (iv) adding a suitable amount of the aqueous solution or emulsion of the polymer, (v) drying the resulting mixture to remove any water, (vi) re-dispersing the dried mixture obtained in step (v), and (vii) optionally adding suitable amounts of an acid, a surfactant, an oxidizing agent, a corrosion inhibitor, or combinations thereof to the mixture. Methods to remove water from the polymer-coated abrasive particles in step (v) are well known in the art and include but are not limited to lyophilization, azeotropic distillation, spray drying, rotary evaporation, and the like.

The polishing composition of the invention can be supplied as a multi-package system with one or more components of the polishing composition in separate compositions that are combined prior to use. For example, a first package can comprise particles of a composite metal oxide abrasive and the water-soluble or water-emulsifiable polymer combined in water, or the first package can comprise the polymer-coated abrasive particles in a dry form. Optional components, such as an acid, a surfactant, an oxidizing agent, a corrosion inhibitor, or combinations thereof, can be placed in a second package or split among a second package and a third package, either in dry form or in the form of an aqueous mixture. If an optional component is an oxidizing agent, it can be provided separately from the other components of the polishing composition. The oxidizing agent desirably is provided separately and is combined, e.g., by the end-user, with the other components of the polishing composition shortly before use (e.g., 1 week or less prior to use, 1 day or less prior to use, 1 hour or less prior to use, 10 minutes or less prior to use, or 1 minute or less prior to use). Other two-package, or three- or more package, combinations of the components of the polishing composition of the invention are within the knowledge of one of ordinary skill in the art.

The invention flintier provides a method of polishing a substrate with the polishing composition described herein. The method comprises the steps of (i) contacting a substrate with a polishing pad and a polishing composition as described herein, (ii) moving the polishing pad relative to the substrate with the polishing composition therebetween, and (ii) abrading at least a portion of the substrate to polish the substrate.

In particular, the invention provides a method of polishing a substrate, which method comprises the steps of (i) contacting a substrate with a polishing pad and a polishing composition comprising (a) particles of an abrasive comprising a first metal oxide and a second metal oxide adhered to at least a portion of a surface of the first metal oxide, (b) a water-soluble or water-emulsifiable polymer, wherein the water-soluble or water-emulsifiable polymer coats at least a portion of the second metal oxide such that the zeta potential of the abrasive is changed, and (c) water, (ii) moving the polishing pad relative to the substrate with the polishing composition therebetween, and (ii) abrading at least a portion of the substrate to polish the substrate.

The polishing composition and method can be used to polish any suitable substrate. A preferred substrate comprises at least one metal layer. Suitable substrates include, but are not limited to, integrated circuits, memory or rigid disks, metals, interlayer dielectric (ILD) devices, semiconductors, micro-electro-mechanical systems, ferroelectrics, and magnetic heads. The metal layer can comprise any suitable metal. For example, the metal layer can comprise copper, tantalum, titanium, tungsten, aluminum, nickel, platinum, ruthenium, iridium, or rhodium. The substrate can further comprise at least one insulating layer. The insulating layer can be a metal oxide, porous metal oxide, glass, organic polymer, fluorinated organic polymer, or any other suitable high or low-κ insulating layer.

A substrate can be planarized or polished with the polishing composition by any suitable technique. The polishing method of the invention is particularly suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate to polish the substrate.

While the polishing composition can be prepared well before, or even shortly before, use, the polishing composition also can be produced by mixing the components of the polishing composition at or near the point-of-use. As utilized herein, the term “point-of-use” refers to the point at which the polishing composition is applied to the substrate surface (e.g., the polishing pad or the substrate surface itself). When the polishing composition is to be produced using point-of-use mixing, the components of the polishing composition are separately stored in two or more storage devices.

In order to mix components contained in storage devices to produce the polishing composition at or near the point-of-use, the storage devices typically are provided with one or more flow lines leading from each storage device to the point-of-use of the polishing composition (e.g., the platen, the polishing pad, or the substrate surface). By the term “flow line” is meant a path of flow from an individual storage container to the point-of-use of the component stored therein. The one or more flow lines can each lead directly to the point-of-use, or, in the case that more than one flow line is used, two or more of the flow lines can be combined at any point into a single flow line that leads to the point-of-use. Furthermore, any of the one or more flow lines (e.g., the individual flow lines or a combined flow line) can fist lead to one or more of the other devices (e.g., pumping device, measuring device, mixing device, etc.) prior to reaching the point-of-use of the component(s).

The components of the polishing composition can be delivered to the point-of-use independently (e.g., the components are delivered to the substrate surface whereupon the components are mixed during the polishing process), or the components can be combined immediately before delivery to the point-of-use. Components are combined “immediately before delivery to the point-of-use” if they are combined less than 10 seconds prior to reaching the point-of-use, preferably less than 5 seconds prior to reaching the point-of-use, more preferably less than 1 second prior to reaching the point of use, or even simultaneous to the delivery of the components at the point-of-use (e.g., the components are combined at a dispenser). Components also are combined “immediately before delivery to the point-of-use” if they are combined within 5 m of the point-of-use, such as within 1 m of the point-of-use or even within 10 cm of the point-of-use (e.g., within 1 cm of the point of use).

When two or more of the components of the polishing composition are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high pressure nozzle or jet) through which two or more of the components flow. Alternatively, the mixing device can be a container-type mixing device comprising one or more inlets by which two or more components of the polishing slurry are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

A substrate can be planarized or polished with the polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. No. 5,196,353, U.S. Pat. No. 5,433,651, U.S. Pat. No. 5,609,511, U.S. Pat. No. 5,643,046, U.S. Pat. No. 5,658,183, U.S. Pat. No. 5,730,642, U.S. Pat. No. 5,838,447, U.S. Pat. No. 5,872,633, U.S. Pat. No. 5,893,796, U.S. Pat. No. 5,949,927, and U.S. Pat. No. 5,964,643. Desirably, the inspection or monitoring of the progress of the polishing process with respect to a workpiece being polished enables the determination of the polishing end-point, i.e., the determining ion of when to terminate the polishing process with respect to a particular workpiece.

The CMP apparatus can further comprise a means for oxidizing the substrate. In electrochemical polishing systems, the means for oxidizing the substrate preferably comprises a device for applying a time-varying potential (e.g., anodic potential) to the substrate (e.g., electronic potentiostat). The device for applying time-varying potential to the substrate can be any suitable such device. The means for oxidizing the substrate preferably comprises a device for applying a first potential (e.g., a more oxidizing potential) during an initial stage of the polishing and applying a second potential (e.g., a less oxidizing potential) at or during a later stage of polishing, or a device for changing the first potential to the second potential during an intermediate stage of polishing, e.g., continuously reducing the potential during the intermediate stage or rapidly reducing the potential from a first, higher oxidizing potential to a second, lower oxidizing potential after a predetermined interval at the first, higher oxidizing potential. For example, during the initial stage(s) of the polishing, a relatively high oxidizing potential is applied to the substrate to promote a relatively high rate of oxidation/dissolution/removal of the substrate. When polishing is at a later stage, e.g., when approaching an underlying banner layer, the applied potential is reduced to a level producing a substantially lower or negligible rate of oxidation/dissolution/removal of the substrate, thereby eliminating or substantially reducing dishing, corrosion, and erosion. The time-varying electrochemical potential is preferably applied using a controllably variable DC power supply, e.g., an electronic potentiostat. U.S. Pat. No. 6,379,223 further describes a means for oxidizing a substrate by applying a potential.

### EXAMPLE

This example further illustrates the invention but, of course, should not be construed as in any way limiting its scope. In particular, this example illustrates the effect of different amounts of an abrasive and of a useful polymer on particle size and zeta potential of polishing compositions of the inventive method. The composite metal oxide particles comprised silica coated with alumina as obtained from Nalco Company, with a mean particle size of about 20 nm and a measured zeta potential of +8 mV. Five polishing compositions were prepared by adding solutions of poly-2-acrylamido-2-methylpropane sulfonic acid to aqueous dispersions of the abrasive, followed by mixing in a high shear mixer for 10 minutes (Compositions 1A, 1B, 1C, 1D, and 1E). The variable parameters were the weight percentages of abrasive and of polymer. Following blending, the mean particle size, zeta potential, and pH of each of the compositions were measured. The results are summarized in Table 1.

TABLE 1
Particle Size and Zeta Potential

| | Weight | | | | | |
|---|---|---|---|---|---|---|
| | Ratio | Polymer | Particle | Mean | Zeta | |
| | Polymer/ | Amount | Amount | Particle | Potential | |
| Composition | Abrasive | (wt. %) | (wt. %) | Size (nm) | (mV) | pH |
| 1A | 0.5 | 1.5% | 3.0% | 277 | −19 | 4.9 |
| 1B | 2 | 3.0% | 1.5% | 80 | −25 | 5.7 |
| 1C | 1 | 3.0% | 3.0% | 158 | −23 | 4.9 |
| 1D | 0.5 | 3.0% | 6.0% | 6435 | −13 | 4.9 |
| 1E | 1 | 6.0% | 6.0% | 665 | −7 | 5.8 |

As is apparent from the results set forth in Table 1, for each of the compositions, the positive zeta potential of the untreated abrasive became negative upon addition of the polymer. The mean particle size of the resulting abrasive particles in Composition 1B, with a 2 to 1 ratio of polymer to abrasive, was about 80 nm with a zeta potential of −25 mV. When the ratio of polymer to abrasive was reduced to 1 to 1 (Composition 1C) or 0.5 to 1 (Composition 1A), the mean particle size of the resulting abrasive particles increased approximately 98% and 246%, and the zeta potentials were less negative at −23 mV and −19 mV, respectively, as compared to Composition 1B. The mean particle size of the resulting abrasive particles at a loading of 6.0 wt. % of abrasive and polymer to abrasive ratios of 0.5 to 1 (Composition 1D) and 1 to 1 (Composition 1E) increased approximately 80-fold and 8-fold, respectively as compared to Composition 1B, and the zeta potentials were less negative at −13 and −7 mV, respectively.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A polishing composition comprising:
(a) about 1 wt. % to about 5 wt. % of particles of an abrasive comprising a first metal oxide and a second metal oxide adhered to at least a portion of a surface of the first metal oxide, wherein the first and second metal oxides are different, and wherein the abrasive has a zeta potential,
(b) a water-soluble or water-emulsifiable polymer, wherein the water-soluble or water-emulsifiable polymer coats at least a portion of the second metal oxide such that the zeta potential of the abrasive is changed, and wherein the polymer and the abrasive are present in a weight ratio of 0.5:1 or more, and
(c) water.

2. The polishing composition of claim 1, wherein the first metal oxide and the second metal oxide are independently selected from the group consisting of alum silica, titania, ceria, zirconia, germania, magnesia, and tantalum oxide.

3. The polishing composition of claim 2, wherein the first metal oxide is silica.

4. The polishing composition of claim 3, wherein the second metal oxide is alumina or ceria.

5. The polishing composition of claim 1, wherein the second metal oxide is adhered to about 5% to about 100% of the surface of the first metal oxide.

6. The polishing composition of claim 5, wherein the second metal oxide is adhered to the first metal oxide through one or more covalent bonds.

7. The polishing composition of claim 1, wherein the abrasive particles have an average diameter of about 5 nm to about 200 nm.

8. The polishing composition of claim 7, wherein the abrasive particles have an average diameter of about 10 nm to about 75 nm.

9. The polishing composition of claim 1, wherein the water-soluble or water-emulsifiable polymer is an anionic polymer comprising repeating units selected from the group consisting of carboxylic acid, sulfonic acid, and phosphonic acid functional groups.

10. The polishing composition of claim 9, wherein the water-soluble or water-emulsifiable polymer comprises repeating units selected from the group consisting of acrylic acid, methacrylic acid, itaconic acid, maleic acid, maleic anhydride, vinyl sulfonic acid, 2-(methacryloyloxy)ethanesulfonic acid, styrene sulfonic acid, 2-acrylamido-2-methylpropane sulfonic acid, vinylphosphonic acid, 2-(methacroyloxy)ethylphosphate, and combinations thereof.

11. The polishing composition of claim 1, wherein the water-soluble or water-emulsifiable polymer is a cationic polymer comprising repeating groups comprising at least one amine group.

12. The polishing composition of claim 11, wherein the water-soluble or water-emulsifiable polymer is a cationic polymer comprising repeating units selected from the group consisting of allylamine, vinylamine, ethyleneimine, vinyl pyridine, diethylaminoethyl methacrylate, diallyldimethylammonium chloride, methacryloyloxyethyltrimethylammonium sulfate, and combinations thereof.

13. The polishing composition of claim 1, wherein the polishing composition has a pH of about 2 to about 12.

14. The polishing composition of claim 13, wherein the pH of the polishing composition is about 3 to about 10.

15. The polishing composition of claim 1, wherein the zeta potential of the abrasive is changed by at least 5 mV.

16. The polishing composition of claim 15, wherein the zeta potential of the abrasive is changed by at least 10 mV.

17. The polishing composition of claim 1, wherein the polishing composition further comprises an acid.

18. The polishing composition of claim 17, wherein the acid is an inorganic acid.

19. The polishing composition of claim 18, wherein the inorganic acid is selected from the group consisting of nitric acid, phosphoric acid, sulfuric acid, and combinations thereof.

20. The polishing composition of claim 17, wherein the acid is an organic acid.

21. The polishing composition of claim 20, wherein the organic acid is selected from the group consisting of oxalic acid, malonic acid, tartaric acid, acetic acid, lactic acid, propionic acid, phthalic acid, benzoic acid, citric acid, succinic acid, and combinations thereof.

22. The polishing composition of claim 1, wherein the polishing composition further comprises one or more components selected from the group consisting of oxidizing agents, corrosion inhibitors, pH adjustors, and surfactants.

23. The polishing composition of claim 22, wherein the polishing composition further comprises an oxidizing agent, and the oxidizing agent is hydrogen peroxide.

24. The polishing composition of claim 22, wherein the polishing composition further comprises a corrosion inhibitor, and the corrosion inhibitor is benzotriazole.

25. The polishing composition of claim 22, wherein the polishing composition further comprises a surfactant, and the surfactant is a nonionic surfactant.

26. A method of polishing a substrate, comprising:
(i) contacting a substrate with a polishing pad and a polishing composition comprising:
(a) about 1 wt. % to about 5 wt. % of particles of an abrasive comprising a first metal oxide and a second metal oxide adhered to at least a portion of a surface of the first metal oxide, wherein the first and second metal oxides are different, and wherein the abrasive has a zeta potential,
(b) a water-soluble or water-emulsifiable polymer, wherein the water-soluble or water-emulsifiable polymer coats at least a portion of the second metal oxide such that the zeta potential of the abrasive is changed, and wherein the polymer and the abrasive are present in a weight ratio of 0.5:1 or more, and
(c) water,
(ii) moving the polishing pad relative to the substrate with the polishing composition therebetween, and
(iii) abrading at least a portion of the substrate to polish the substrate.

27. The method of claim 26, wherein the first metal oxide and the second metal oxide are independently selected from the group consisting of alumina, silica, titania, ceria, zirconia, germania, magnesia, and tantalum oxide.

28. The method of claim 27, wherein the first metal oxide is silica.

29. The method of claim 28, wherein the second metal oxide is alumina or ceria.

30. The method of claim 26, wherein the second metal oxide is adhered to about 5% to about 100% of the surface of the first metal oxide.

31. The method of claim 30, wherein the second metal oxide is adhered to the first metal oxide through one or more covalent bonds.

32. The method of claim 26, wherein the abrasive particles have an average diameter of about 5 nm to about 200 nm.

33. The method of claim 32, wherein the abrasive particles have an average diameter of about 10 nm to about 75 nm.

34. The method of claim 26, wherein the water-soluble or water-emulsifiable polymer is an anionic polymer comprising repeating units selected from the group consisting of carboxylic acid, sulfonic acid, and phosphonic acid functional groups.

35. The method of claim 34, wherein the water-soluble or water-emulsifiable polymer comprises repeating units selected from the group consisting of acrylic acid, methacrylic acid, itaconic acid, maleic acid, maleic anhydride, vinyl sulfonic acid, 2-(methacryloyloxy)ethanesulfonic acid, styrene sulfonic acid, 2-acrylamido-2-methylpropane sulfonic acid, vinylphosphonic acid, 2-(methacroyloxy)ethylphosphate, and combinations thereof.

36. The method of claim 26, wherein the water-soluble or water-emulsifiable polymer is a cationic polymer comprising repeating groups comprising at least one amine group.

37. The method of claim 36, wherein the water-soluble or water-emulsifiable polymer is a cationic polymer comprising repeating units selected from the group consisting of allylamine, vinylamine, ethyleneimine, vinyl pyridine, diethylaminoethyl methacrylate, diallyldimethylammonium chloride, methacryloyloxyethyltrimethylammonium sulfate, and combinations thereof.

38. The method of claim 26, wherein the polishing composition has a pH of about 2 to about 12.

39. The method of claim 38, wherein the pH of the polishing composition is about 3 to about 10.

40. The method of claim 26, wherein the zeta potential of the abrasive is changed by at least 5 mV.

41. The method of claim 40, wherein the zeta potential of the abrasive is changed by at least 10 mV.

42. The method of claim 26, wherein the polishing composition further comprises an acid.

43. The method of claim 42, wherein the acid is an inorganic acid.

44. The method of claim 43, wherein the inorganic acid is selected from the group consisting of nitric acid, phosphoric acid, sulfuric acid, and combinations thereof.

45. The method of claim 42, wherein the acid is an organic acid.

46. The method of claim 45, wherein the organic acid is selected from the group consisting of oxalic acid, malonic acid, tartaric acid, acetic acid, lactic acid, propionic acid, phthalic acid, benzoic acid, citric acid, succinic acid, and combinations thereof.

47. The method of claim 26, wherein the polishing composition further comprises one or more components selected from the group consisting of oxidizing agents, corrosion inhibitors, pH adjustors, and surfactants.

48. The method of claim 47, wherein the polishing composition further comprises an oxidizing agent, and the oxidizing agent is hydrogen peroxide.

49. The method of claim 47, wherein the polishing composition further comprises a corrosion inhibitor, and the corrosion inhibitor is benzotriazole.

50. The method of claim 47, wherein the polishing composition further comprises a surfactant, and the surfactant is a nonionic surfactant.

51. The method of claim 26, wherein the method further comprises detecting in situ a polishing endpoint.

52. The method of claim 26, wherein the polishing pad is an electrically conducting polishing pad, and the polishing composition is an electrolytically conductive fluid, and the method further comprises applying an anodic potential to at least the portion of the substrate contacted by the polishing composition.
